(19) United States
(12) Patent Application Publication
(10) Pub. No.: US 2026/0080562 A1
(43) Pub. Date: Mar. 19, 2026

(54) Method for Determining an Actual Distribution of Fertilizer Grains

(71) Applicant: Amazonen-Werke H. Dreyer SE & Co. KG, Hasbergen-Gaste (DE)

(72) Inventors: Justus DREYER, Osnabrück (DE); André GROßE BRINKHAUS, Münster (DE); Per-Christian HEISEL, Osnabrück (DE); Arnd KIELHORN, Osnabrück (DE); Florian RAHE, Lotte (DE); Markus STRÖBEL-FRÖSCHLE, Georgsmarienhütte (DE)

(73) Assignee: Amazonen-Werke H. Dreyer SE & Co. KG, Hasbergen-Gaste (DE)

(21) Appl. No.: 19/108,963

(22) PCT Filed: Jul. 20, 2023
(86) PCT No.: PCT/EP2023/070136

§ 371 Date: Mar. 5, 2025

(30) Foreign Application Priority Data
Sep. 15, 2022 (DE) 10 2022 123 599.8

(51) Int. Cl. G06T 7/73; G06V 10/25; G06V 10/26; G06V 10/36; G06V 10/764; G06V 10/82; H04N 23/60

(52) U.S. Cl. CPC G06T 7/73; G06V 10/25; G06V 10/267; G06V 10/36; H04N 23/64; G06T 2207/20084; G06T 2207/20132; G06T 2207/30188; G06V 10/764; G06V 10/82

(57) ABSTRACT

A method for determining an actual distribution of fertilizer grains comprising the steps of laying out at least one collecting device for fertilizer grains; spreading the fertilizer grains over the at least one collecting device using a fertilizer spreader; taking a picture of the at least one collecting device on which fertilizer grains have been spread with a camera; localizing the fertilizer grains in the picture, and calculating an actual distribution of the fertilizer grains on the collecting device and/or along several collecting devices, the method comprising at least one improvement step which improves the localization of the fertilizer grains in the picture.

### CROSS REFERENCE TO RELATED APPLICATIONS

The present application claims priority under 35 U.S.C. § 365 to PCT/EP2023/070136 filed on Jul. 20, 2023 and under 35 U.S.C. § 119(a) to German Application No. 10 2022 123 599.8 filed on Sep. 15, 2022, both of which are incorporate by reference in their entireties.

### TECHNICAL FIELD

The disclosure relates to a method for determining the actual distribution of fertilizer grains and a system for taking a picture in such a method.

### BACKGROUND

When distributing fertilizer grains, the spreading pattern of a fertilizer spreader is based on the flow behavior and flight behavior of the fertilizer grains. These depend, among other things, on grain size, grain shape, true density, bulk density, grain strength, moisture, friction coefficient and surface properties of the grains. In principle, there are recommended settings for different fertilizer spreaders, in particular different centrifugal discs, which can be retrieved from databases or read from so-called spreading tables, taking into account the respective fertilizer type. However, deviations from the expected spreading pattern may occur, for example, due to deviations in fertilizer quality, changes in the inclination of the spreader, spreading mechanism and/or centrifugal disc(s), wind, moisture content of the fertilizer, changes in quantity and/or segregation of the grain size fractions. Consequently, the actual distribution of the fertilizer, in particular with regard to the transverse distribution, must be checked in practical application.

For this purpose, for example, it is known from EP 2 923 546 B1 to use an adhesive mat/plate to catch and hold spread fertilizer grains, to spread fertilizer grains over this mat/plate, and to determine the distribution of fertilizer grains that have arrived on the adhesive mat/plate.

### SUMMARY

The disclosure is based on the object of specifying an improved method for determining an actual distribution of fertilizer grains and a system for taking a picture in such a method.

The method for determining an actual distribution of fertilizer grains comprises the steps of laying out at least one collecting device for fertilizer grains; spreading the fertilizer grains over the at least one collecting device using a fertilizer spreader, in particular a centrifugal fertilizer spreader; taking a picture of the at least one collecting device on which fertilizer grains have been spread with a camera; localizing the fertilizer grains in the picture, and calculating an actual distribution of the fertilizer grains on the collecting device and/or along several collecting devices, wherein the method comprises at least one improvement step that improves the localization of the fertilizer grains in the picture.

At least one collecting device is laid out in the process. In particular, one, two, three or more collecting devices may be laid out. The at least one collecting device is typically laid out in such a way that it is located in an area where fertilizer grains are expected to land when being spread. A collecting device may in particular comprise or be an adhesive mat/plate as described in EP 2 923 546 B1. Alternatively, a collecting device may comprise or be, for example, a measuring tray as described in DE 10 2004 017 075 A1, other measuring trays or another device that is suitable for holding fertilizer grains at or near the point of impact, for bringing them to rest or for collecting them. A combination of different collecting devices, for example one or more measuring trays and one or more adhesive mats, may also be used.

The fertilizer grains are spread by a fertilizer spreader, for example a centrifugal fertilizer spreader or a pneumatic fertilizer spreader. This fertilizer spreader may be a centrifugal fertilizer spreader. It may comprise at least one, typically two, centrifugal discs, wherein the centrifugal disc(s) may in particular be driven in rotation. Alternatively, the fertilizer spreader may also be a pneumatic spreader that applies fertilizer pneumatically via at least one pneumatic conveyor line with one or more associated baffle plates. The fertilizer spreader may also comprise a storage container and a metering unit. Typically, the fertilizer grains are introduced via the metering unit to the spreading mechanism, e.g. onto a centrifugal disc or into the pneumatic system. For example, the fertilizer spreader may comprise a metering unit for each centrifugal disc or for each pneumatic conveyor line, via which the fertilizer grains (the fertilizer) can be applied in adjustable quantities to the centrifugal disc or in the pneumatic conveyor line. In the case of a pneumatic fertilizer spreader, the metering unit may be, for example, a section of a metering drum.

For example, the fertilizer spreader may comprise two centrifugal discs arranged side by side transversely to the intended direction of travel, wherein each centrifugal disc may comprise one, two or more throwing vanes. A fertilizer grain feed system may be arranged for each centrifugal disc, which is configured to feed the fertilizer grains in an adjustable manner in the radial and/or concentric direction to a point on the centrifugal disc (feeding point). The fertilizer spreader's spreading pattern can be influenced by adjusting one or more fertilizer spreader parameters, in particular, for example, the position of the throwing vanes on the centrifugal discs, the diameter of the centrifugal discs, the effective length of the throwing vanes, the mounting height of the centrifugal spreader, the inclination of the centrifugal spreader and/or the inclination of the spreading mechanism and/or the centrifugal discs, the speed of the centrifugal discs and/or the feeding point of the fertilizer grains on the centrifugal disc.

A camera that may be used to take a picture of the at least one collecting device on which fertilizer grains have been spread may be a digital camera, in particular the camera of a mobile device, such as a cell phone or tablet. When taking a picture, the collecting device may be included in at least one camera picture.

In the picture, the fertilizer grains are localized. The localization of the fertilizer grains may be carried out on a mobile device, the on-board computer or on a server. In particular, a picture analysis may be carried out in which a step is carried out that distinguishes fertilizer grains from the collecting device, e.g. on the basis of color differences, structure, deviation from an even pattern or a flat surface and/or shadow casting. Subsequently, an actual distribution of the fertilizer grains on the collecting device or along several collecting devices may be determined, for example by evaluating the area covered by fertilizer grains compared to the area visible of the collecting device's base and/or based on the known dimensions of the collecting device. In particular, an actual distribution of the fertilizer grains on the collecting device may be calculated on one collecting device and/or along several collecting devices.

The improvement step improves the localization of the fertilizer grains in the image. For example, such an improvement step may comprise an improvement of the picture quality or the image evaluation (compared to a method without such a step).

For example, the improvement step may comprise capturing at least one circumstantial parameter before taking the picture. A circumstantial parameter may in particular describe one or more circumstances before and/or during taking the picture.

Such a circumstantial parameter may, for example, comprise information about the environment, information about the camera, information about the collecting device, information about the current picture quality and/or further information. For example, the at least one circumstantial parameter may include light conditions (in particular, e.g., brightness), a time of day, a shadow cast, in particular by a machine, e.g. the fertilizer spreader, the position of the sun, the current cloud cover, the compass direction, in particular with respect to the position of the camera, e.g., with respect to a machine, in particular the fertilizer spreader, and/or the direction of picture taking, calculated (harsh) shadows that fall on the collecting device or that are generated by the structure of the collecting device and the light conditions, a GPS position, the inclination of the ground and/or the collecting device, a mounting and/or orientation of the camera, a position (in particular distance to the target area) of the camera, a tilt of the camera, information about the shape of the collecting device, information about a labeling or marking on the collecting device, information about the camera, e.g. model, manufacturer, active settings of the camera, e.g. active filters, focal length, aperture, exposure time, sensitivity, resolution, information about a mobile device (which may comprise the camera, for example) such as the operating system and operating system version, the recording software, the version of the recording software, and/or similar. Such a circumstantial parameter may be taken into account when taking the picture and/or during evaluation.

On the basis of the at least one captured circumstantial parameter, at least one setting parameter may be adjusted when taking the picture. For example, the exposure time and/or sensitivity may be adjusted to the lighting conditions, the desired recording direction to the compass direction, in particular with regard to the position of the camera, e.g. in relation to a machine, e.g. the fertilizer spreader, and/or the direction of picture taking, and/or the position of the sun and/or the calculated shadow. Alternatively or additionally, it may be checked or set that no filters and/or certain filters are applied.

For example, a predetermined resolution (optionally without a filter) may be used for taking a picture. This may, for example, enable a standardized evaluation and ensure compatibility when changing hardware. For example, the resolution may be FHD (Full High-Definition—1920×1080) and/or the optimal resolution of the camera may be used and scaled down to FHD (or another predetermined resolution). For example, a whole number of pixels may be combined, e.g. 2×2 or 3×3 pixels combined. This reduces the resolution to a fraction of the previous resolution, wherein the previous resolution is a multiple of the resulting resolution. This may be computationally advantageous and may also increase accuracy by reducing the influence of pixel errors or the like. If the previous resolution is reduced to a non-integer factor, pixels must be interpolated. In particular, this may cause sharp edges to become blurred.

The at least one circumstantial parameter may comprise an environmental parameter and/or a fertilizer spreader parameter.

Exemplary environmental parameters may comprise, for example, light conditions, the position of the sun, cloud cover, compass direction, calculated shadow casting, e.g. calculated (harsh) shadows cast on the collecting device, in particular by the structure of the collecting device or a machine, e.g. the fertilizer spreader, and/or similar. Fertilizer spreader parameters may, for example, comprise one or more of the above-mentioned fertilizer spreader parameters, in particular the control setting(s), e.g. speed, spreading width, working width, feeding point, discharge angle, metered quantity, and/or property(properties) of the fertilizer, in particular, for example, grain size, mean grain size, surface properties of the fertilizer grains, size distribution of the fertilizer grains, grain shape, true density, bulk density and/or grain strength. The fertilizer spreader parameters may, for example, be stored (in particular in an app), e.g. in a mobile device, the on-board computer or on a server, which may optionally also be configured to carry out one or more further steps of the method.

For example, in the case of a fertilizer spreader, taking into account an environmental parameter, the lighting of the fertilizer spreader, in particular work lighting directed onto the surface or the spreading fan, in particular the collecting devices, may be switched on as a setting parameter if this can contribute to an image improvement due to the lighting conditions.

The at least one circumstantial parameter may comprise, in particular, a camera parameter, for example the camera setting, the type of filter activated in the camera, the white balance set for the camera, the exposure time, the focal length, the sensitivity, the aperture, the ISO setting, an image parameter (e.g. sharpness and/or resolution) and/or further (shooting) settings.

For example, a setting parameter of the camera, e.g. an exposure time, the selected white balance, an ISO setting, focal length, aperture, a filter, a camera angle, tilt angle and/or other camera settings may be adjusted, in particular set to a (new, calculated) nominal value, on the basis of at least one circumstantial parameter, in particular a camera parameter. Such an adjustment of one (or more) setting parameters to a (new, calculated) nominal value may be carried out in particular on the basis of at least one circumstantial parameter, e.g. a previously measured or known actual value.

For example, a white balance may be set on the basis of at least one circumstantial parameter, e.g. the measured value of a color chart or reference color in the picture, which may be visible on the collecting device and/or may use the color of the fertilizer, and thus the camera setting parameter indicating the white balance may be set appropriately for taking the picture. Alternatively or additionally, lighting conditions and/or camera sensitivity may be used as circumstantial parameters to adjust one or more camera setting parameters.

Optionally, for example if the at least one circumstantial parameter comprises a camera parameter, instructions for improving the at least one camera parameter may be issued. For example, the user may be instructed to change their position, e.g. if the user is otherwise casting an unfavorable shadow and/or if the camera is being held in an unfavorable manner (e.g. tilted).

If, for example, a camera parameter detects that the picture is unsuitable (e.g. it is not sharp, distorted due to excessive camera tilt, comprises strong harsh shadows and/or is incorrectly exposed), it may be rejected. The user may be instructed to improve at least one camera parameter, e.g. to change the exposure time, to change the inclination of the camera and/or to take a picture from a better position. Such instructions may be provided, for example, by guiding the user using a visual and/or acoustic signals. For example, the user may be guided in the correct direction by arrows on a mobile device, e.g. in the camera display of a mobile device, and/or by acoustic signals, e.g. a voice output or an alarm signal in the event of poor positioning, to improve the position. Alternatively or in addition, the user may be guided using augmented reality. For example, the picture from the camera may be overlaid with help for the user, e.g. to indicate a suitable inclination, position, orientation and/or other camera parameters.

For example, instructions may be provided to deliberately take a picture at an oblique angle to the collecting device to avoid harsh shadows. In particular, the camera parameter may comprise (or be) a parameter that describes whether the edge of the collecting device remains in the picture. If it does not, the picture cannot be cropped to the collecting device, so information about the area of the collecting device may be lost. In such a case, the user may be guided, for example, to change the picture section. The guidance may be provided, for example, visually, by arrows or similar, by outputting pictures on the screen and/or by an audio guide.

Optionally, the picture may be taken automatically when the at least one camera parameter meets one or more determining condition(s). For example, continuous or intermittent picture taking (similar to a movie recording or continuously taken individual still images) may be carried out and an automatic shutter-release may be carried out when the collecting device is correctly in the picture, for example when it is (e.g. recognized as correctly positioned by markings) sharp, complete and optionally undistorted in the picture. In other embodiments, distortion may be tolerated during automatic recording and later removed based on the known geometry of the collecting device.

Optionally or additionally, image stabilization, e.g. using an image stabilizer in hardware or software, may be carried out, for example if it is detected on the basis of a camera parameter that the image is blurred, under certain determining condition(s) or always.

The improvement step may comprise detecting a region of interest, for example detecting when the collecting device is fully in the picture. Optionally, the picture in which a region of interest has been detected may be cropped to this region. Such detection of a region of interest may be carried out, for example, before taking the picture or after taking the picture. Thus, a picture may be cropped to the section of a collecting device so that it only comprises the regions in the resulting (cropped) picture that are relevant for determining the actual distribution of the fertilizer grains.

Furthermore, the improvement step may additionally or alternatively comprise an image processing step that improves the distinguishing of the fertilizer grains from the background. All previously determined circumstantial parameters and further parameters may be fed into this improvement step, for example, information about the fertilizer type and/or information about the collecting device, e.g. the mat, or other information. For example, if the type, in particular the color of the fertilizer type, the color of the mat and optionally other parameters, e.g. the white balance, are known, the fertilizer grains may be localized in an image based on these color distributions.

Optionally, the image processing step, which improves the distinguishing of the fertilizer grains from the background, may comprise a filtering step.

For example, the filtering step may comprise a convolution step. A convolution may, for example, comprise pixel-wise iterative routines which process a partial environment of a picture, in particular an environment of a few pixels, e.g. all direct neighbors or a certain number of pixels around the pixel currently being processed, and thus may improve distinguishing the fertilizer grains from the substrate, in particular may emphasize picture characteristics relevant to the spreading pattern. For example, a convolution step may be performed using a convolution kernel. Such a convolution step may, for example, sharpen (some or all edges) of the image and/or accentuate properties of the picture and/or adjust other properties of the picture.

Alternatively or additionally, the filtering step may comprise a filtering step with a specialized filter that has been laid out and/or trained on the basis of existing pictures.

In addition or alternatively, the filtering step may comprise a dilation step and/or an erosion step and/or a histogram adjustment (and/or a contrast stretching).

In a dilation step, structures on an image may be adjusted, in particular, existing structures may be emphasized, for example using a structured element, for example fertilizer grains present in an image may be enlarged so that they may be better recognized in the subsequent processing.

In the case of erosion, structures on an image may be removed, for example by using a mask. This may lead to the shape of the existing structures, for example, fertilizer grains, being more easily recognizable, wherein fertilizer grains that may be touching one another in the picture may be more easily separated.

A histogram may describe the brightness and/or contrast and/or color values of an image. In a histogram adjustment, the brightness and/or contrast may be adjusted, e.g. to a reference histogram. For example, the histogram adjustment may comprise the brightness being distributed evenly over the image. This may lead to an improved distinction of the fertilizer grains from the background, especially in unfavorable lighting conditions or shadows. Similarly, contrast stretching (distribution of the measured brightness over the entire possible range) may lead to an improved distinction of the fertilizer grains from the background.

A histogram may describe the brightness distribution of the pixels in the image. The filtering step may comprise a fast Fourier transform and/or threshold filtering.

A fast Fourier transform, for example, may allow the image information to be viewed in the frequency domain. It may thus optionally filter out of the picture, for example with an additional filter, image information at a certain frequency, such as that which may be generated by the structure of a collecting device. In particular, a fast Fourier transform may be used to only look at frequencies in the picture that are smaller than a regularly recurring structure of the collecting device, so that only the (irregular) fertilizer distribution is detected, but not a regular structure of the collecting device.

Threshold filtering may comprise, for example, filtering with a grey-scale value of a pixel, a specific color value of a pixel or similar. Using such threshold filtering, in particular if the color of the fertilizer and/or the color of the collecting device is known, it is possible, for example, to distinguish whether a pixel is to be assigned to fertilizer or to the collecting device.

The image processing step that improves distinguishing the fertilizer grains from the background may comprise one or more of the aforementioned steps, for example a convolution step with a fast Fourier transform and optionally further steps.

The improvement step may be adapted in consideration of the at least one circumstantial parameter, for example, one or more parameters that are fed into the improvement step may be checked on the basis of the at least one circumstantial parameter and, if they do not correspond to the intended value, selected or redefined. Thus, the improvement step may be adapted to one or more circumstances (at or before) taking the picture, which may, in particular, prepare an optimal evaluation of the picture.

For example, an image processing step may be adjusted taking into account the at least one circumstantial parameter, in particular, for example, brightness, cloudiness, shadows, lighting conditions, type of fertilizer, frequency and/or regularity of the structure of a collecting device and/or color of a collecting device. For example, the frequencies considered in a fast Fourier transform may be adjusted taking into account the frequency of the structure of the collecting device, a threshold filtering may be adjusted to the brightness and/or light conditions and/or a histogram adjustment may be adjusted to the light conditions and/or shadows.

In sunlight and shade, the improvement step may comprise a histogram adjustment (in particular locally), taking into account the exposure conditions, in particular the sunlight and the shade, in order to generate a uniform picture.

Alternatively or additionally, in the case of small fertilizer grains, the improvement step may comprise an adjustment of a Fourier filter in order to map the small structures of the fertilizer grains if necessary. Alternatively or additionally, no erosion filter may be used in the improvement step in order not to reduce the size of the small fertilizer grains in the picture even further.

If the focal length is short, the improvement step may comprise rectifying the image, since stronger distortions occur at the edges.

For example, an AI may be used to adjust the improvement step taking into account the at least one circumstantial parameter. In this case, in particular, circumstantial parameters taken into account in the improvement step and/or steps carried out in the process may be selected and/or combined on the basis of the circumstances, which may be described in particular by the circumstantial parameters.

The improvement step may comprise a training step for future steps of a method for determining an actual distribution of fertilizer grains. In particular, the training step may serve to improve the method based on the experience gained. For example, the step of taking a picture, the step of localizing the fertilizer grains in the picture, parts thereof and/or intermediate steps for this may be trained in the training step. In particular, one or more image processing steps (for future image processing) may be trained in a training step.

In particular, a training step may be carried out, for example, after calculating an actual distribution of the fertilizer grains on the collecting device and/or along several collecting devices.

The training step may, for example, be carried out by an Al. The Al may, for example, be the Al of a mobile device, e.g. the Al of a smartphone or tablet.

In the training step, one or more intermediate results from one or more methods for determining the actual distribution and/or one or more previously calculated actual distributions of the fertilizer grains may be taken into account, e.g. as feedback. This training step may be carried out, for example, after each calculation of an actual distribution of the fertilizer grains, after a certain number of calculations of an actual distribution of the fertilizer grains, after a certain period of time, at the user's request and/or according to other criteria.

The training step may take into account one or more user inputs. For example, the user may enter the amount of fertilizer applied and/or other information that may be used to check the plausibility of the actual distribution being calculated, or similar. Alternatively, or in addition, a user input may comprise a user assessment, in particular as feedback. In particular, such a user evaluation may be used to determine whether the improvement step was successful, in particular, for example, whether further steps of an improvement step, e.g. one or more further training or compensation steps, should be carried out.

The improvement step may comprise a compensation step for contaminants detected on the collecting device. For example, these may be identified in the picture based on their structure, size and/or color. For example, structures on the collecting device that are significantly larger or significantly smaller than fertilizer grains may be identified as contaminants. Alternatively or additionally, structures on the collecting device that have a different color than the collecting device and/or the fertilizer grains may be recognized as contaminants. Alternatively or additionally, structures on the collecting device that have a different geometry than fertilizer grains may be recognized as contaminants. Another geometry may in particular comprise that the contaminants, e.g. plant residues or leaves, have a dimension that is a multiple of the mean grain size of the fertilizer used. This means that they may be ignored when localizing the fertilizer grains in the picture, for example, by not taking them into account during image processing after they have been identified as contaminants.

Typically, the evaluation is done on a pixel-by-pixel basis. In particular, the detected grains may be provided with a pixel-by-pixel mask and thus marked. When detecting contaminants, all pixels that are assigned to contaminants may then be removed from the pixel-by-pixel marking of fertilizer grains, leaving only the fertilizer grains.

The image processing may be parallelized. For example, during image processing, the picture may be divided into partial pictures, which are processed separately and optionally simultaneously, wherein the results are then combined. For example, the picture may be divided into as many partial pictures (or a multiple of this number) as there are processor cores available on the mobile device for image processing, or it may be divided into a predetermined number of partial pictures, as pictures can be processed in parallel on a server used for image processing.

An improvement step may further comprise guiding a user through the imaging process. For example, a user may be visually and/or acoustically guided through the imaging process. For example, on a camera, for example a camera of a mobile device, the next steps to be performed by the user may be visually indicated (and/or acoustically output) by signals.

For example, the user may be guided to take a picture of at least one collecting device next. Based on environmental parameters, the user may be guided to take a picture from a certain angle and/or with certain camera settings. The user may, for example, be instructed to change the recording position, for example if a previous picture was blurred and/or distorted and/or if, on the basis of the environmental parameters, in particular comprising the camera settings, a good picture, in particular a picture suitable for evaluation, is not expected at the current position. This may be the case, for example, if overexposure is imminent due to the camera being pointed towards the sun or if a shadow is cast with the sun. Such user guidance may be provided, for example, by displaying arrows on a camera display or by acoustically outputting instructions or beeps. A user may be alerted, for example visually or acoustically, if the section captured by the picture is not suitable, for example if only part of the collecting device is shown, if shadows are visible on the picture and/or if the picture is distorted.

The user may also be guided to take a picture of a specific collecting device next, especially if more than one collecting device is laid out on a field. After taking a picture of this collecting device, the user may be guided to take a picture of a next receiving device, wherein the order of the collecting devices to be taken may optionally be specified and may optionally also be changed. This may be particularly advantageous for complex design patterns of the receiving devices. For example, the user may be guided to record several collecting devices (if available) in a particular row. This means that the order in which collecting devices are to be recorded may be controlled and thus known.

In the subsequent evaluation, the position and/or identifier of each collecting device must be known in order to calculate an actual distribution of fertilizer grains. For example, the user interface of the camera and/or the mobile device may be used to guide the user and instructions may be displayed on the user interface. In this case, the information may be output in the same setting as the user interface of the camera or in a different way, for example optically or acoustically as text.

In particular, instructions for improving a camera parameter as described above or another parameter, for example as described above for a camera parameter, may be provided when guiding the user. The guidance may be provided visually, for example, by arrows or similar, by displaying images on the screen and/or by audio guidance.

Optionally, the picture may be taken automatically, e.g. when at least one camera parameter or other parameter fulfills one or more determining condition(s). For example, continuous image recording (similar to a movie recording or continuously recorded individual still images) may be carried out and an automatic shutter-release may be triggered when the collecting device is correctly in the picture, for example when it is (e.g. recognized as correctly positioned by markings) sharp, complete and optionally not distorted in the picture. During continuous image recording, the user may be guided to change the position in a direction desired for image taking, e.g. to move or tilt the camera in a certain direction.

Likewise, the recording mode may be adjusted, for example, using an environmental parameter such as light conditions (e.g. brightness), the position of the sun or cloud cover, for example, a flash may be switched on, external lighting may be switched on and/or a different evaluation routine may be used (e.g. a different filtering step, different white balance, different threshold values, additional steps such as contrast or histogram adjustment and/or similar).

When calculating the actual distribution of the fertilizer grains, information about the collecting device may be taken into account. In particular, the geometry and/or the area and/or the color and/or a (regular) structure of the collecting device and/or an expected image property based on the (regular) structure of the collecting device, for example, shadows generated by a structure of the collecting device, may be taken into account. In particular, one or more of these pieces of information about the collecting device may be taken into account in the image processing step, so that it is thereby taken into account in the actual distribution of the fertilizer grains.

In particular, for example, the known geometry of the collecting device may be used to determine the camera inclination in the event of a distorted representation in the image. This camera inclination may be taken into account in the image processing step.

For example, the camera inclination may be taken into account by determining the dimensions of the collecting device on the basis of the known geometry of the collecting device and by calculating the camera inclination. Optionally, only a region of interest of the collecting surface may be considered, in particular in the image processing step, since the rest of the collecting device may be derived from the dimensions of the region under consideration when the image is cropped. Alternatively or additionally, image areas with display defects, e.g. shadows, may be ignored in this way during the evaluation.

The improvement step may comprise a pixel-wise image segmentation using a neural network.

After the picture has been taken, the picture may be segmented pixel by pixel, for example by a neural network. In this way, for example, the fertilizer grains may be highlighted using a neural network and thus more easily recognized in the further image evaluation.

In addition or as an alternative, the improvement step may comprise a classification or marking of recognized objects by a neural network. For example, a neural network may be used to recognize objects and to classify or mark them in the picture. In this way, for example, the fertilizer grains and/or contaminants may be classified or marked, and further evaluation may be carried out on this basis. If, for example, the fertilizer grains have been classified or marked, a counting of the grains may be facilitated in the further method. Alternatively or additionally, an area (from the classification or the pixel-wise segmentation) may be used for evaluation. Furthermore, the improvement step may comprise a filtering by using a specially trained neural network. By use of such a trained neural network, for example, an optimized filter may be determined with the help of one or more circumstantial parameters, such as lighting or information on white balance, and this may be applied to the images. This may lead to easier and better evaluation during image evaluation.

The disclosure further comprises a system for taking a picture in a method for determining an actual distribution of fertilizer grains as described above. The system comprises, in particular, a screen (display), a processor and a memory. The memory comprises instructions that, when carried out by a processor, visually and/or audibly guide a user to taking a picture of the at least one collecting device on which fertilizer grains have been spread. The guidance may, for example, be provided as described above.

The system's memory may further optionally comprise instructions which, when carried out by a processor, perform the steps of localizing the fertilizer grains in the picture, and calculating an actual distribution of the fertilizer grains on the collecting device and/or along several collecting devices, wherein at least one improvement step improves the localization of the fertilizer grains in the picture. Such an improvement step for localizing the fertilizer grains in the picture may in particular comprise one or more of the improvement steps and measures described above.

The system may further comprise a means of communication of the imaging device that may allow communication with an on-board computer, for example, e.g. a wireless communication module or a connection for a cable. Accordingly, the on-board computer may also comprise a means of communication suitable for connecting to the imaging device, for example, a wireless communication module (matching the communication module of the imaging device) or a connection for a cable (suitable for connecting the imaging device). The system may optionally comprise one or more collecting devices.

If the actual distribution of fertilizer grains is to be determined on more than one collecting device, the system may recommend or adjust an order in which the pictures of the collecting devices are to be taken.

In particular, when the user is guided visually, the screen display may be adapted to one or more environmental parameters. For example, the screen display may be adapted, e.g. the brightness increased or a night display mode activated, based on an environmental parameter such as brightness, the position of the sun or cloud cover.

### BRIEF DESCRIPTION OF THE DRAWINGS

Aspects of the above disclosure can be seen in the attached figures, which are not to scale.

FIG. 1 shows exemplary steps of a method in which a circumstantial parameter is captured,

FIG. 2 shows exemplary steps of a method in which fertilizer grains are localized,

FIG. 3 shows exemplary steps of a method with an improvement step,

FIG. 4: exemplary method steps with a training step,

FIG. 5: an exemplary user interface.

### DETAILED DESCRIPTION

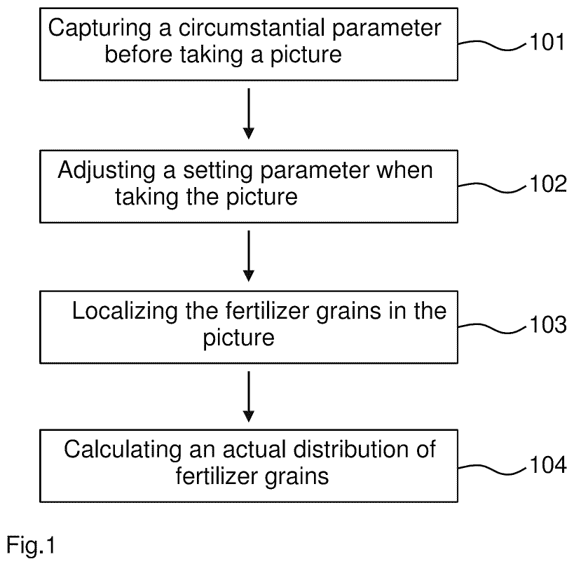

FIG. 1 shows exemplary method steps. In particular, FIG. 1 shows that at least one circumstantial parameter may be captured (step 101) before or during the taking of the picture. For example, the brightness may be captured before taking the picture.

On the basis of the at least one circumstantial parameter, one or more setting parameters may be adjusted when taking the picture (step 102). For example, the exposure time may be adjusted according to the brightness. The picture may then be taken with the adjusted setting parameter. This may improve the localization of the fertilizer grains in the picture (step 103) and a subsequent calculation of an actual distribution of the fertilizer grains on the collecting device and/or along several collecting devices (step 104).

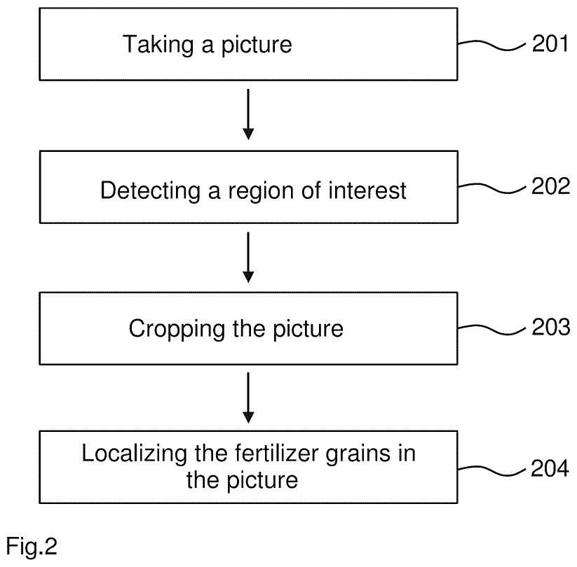

FIG. 2 shows exemplary steps of a method. In the example shown, a picture is taken (step 201). Subsequently, a region of interest is detected in the picture (step 202). The picture may then be cropped to the region of interest (step 203). In the (cropped) picture, the fertilizer grains may then be localized (step 204).

In other examples (not shown), the detection of a region of interest may be performed before taking the picture. For example, a region of interest may be detected during continuous picture taking (similar to a movie recording or continuously taken individual still images). An automatic shutter-release (or a signal to the user) may then happen, for example, when the region of interest (e.g. the complete collecting device) has been detected and is correctly in the picture, for example, when it is recognized as correctly positioned (e.g. on the basis of markings or an expected shape of the mat in the picture) and is sharp and completely in the picture.

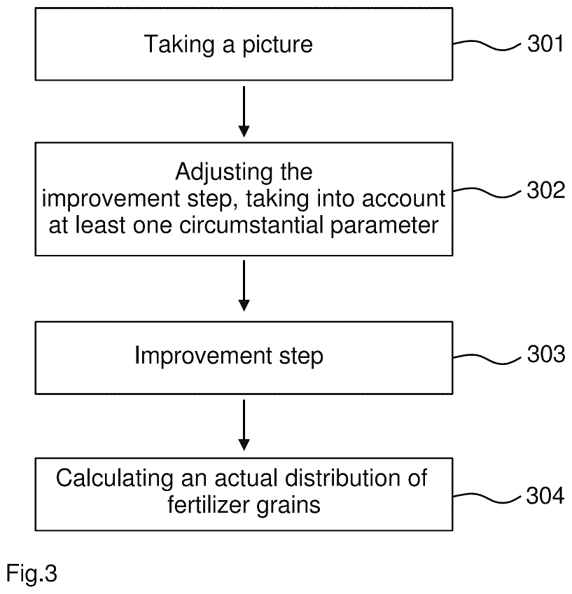

FIG. 3 shows exemplary steps of a method starting with taking a picture (step 301). After taking a picture, the improvement step is adjusted taking into account at least one circumstantial parameter (step 302). In other examples (not shown here), an adjustment of the improvement step may already be made before or when taking the picture, taking into account at least one circumstantial parameter.

For example, the image processing step, e.g. the selection of filters, may be carried out taking into account at least one circumstantial parameter. For example, a filter used, e.g. a threshold, may be adjusted on the basis of brightness. Alternatively or additionally, a filter, e.g. a threshold, may be adjusted on the basis of one or more circumstantial parameters relating to the fertilizer and/or the collecting device, e.g. the color of the fertilizer and/or the collecting device.

After the improvement step has been adapted taking into account at least one circumstantial parameter, the improvement step (step 303) may be carried out and an actual distribution of the fertilizer grains calculated (step 304).

The improvement step that improves the localization of the fertilizer grains in the picture may optionally be comprised as part of taking a picture and/or as part of localizing the fertilizer grains in the picture, e.g. during image processing. For example, an improvement step comprising a filtering step may be comprised as part of the image processing, in particular as part of the step of localizing the fertilizer grains in the recording.

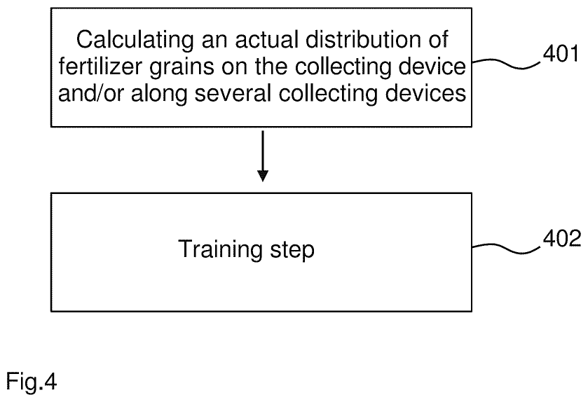

FIG. 4 shows further exemplary method steps. In particular, FIG. 4 shows a training step (step 402), in particular for future steps of a method for determining an actual distribution of fertilizer grains. Such a training step (step 402) may be carried out, for example, after calculating an actual distribution of the fertilizer grains on the collecting device and/or along several collecting devices (401).

Such a training step may, for example, take into account the actual distribution of the fertilizer grains, user input and/or one or more intermediate results from a method for determining the actual distribution. It may, for example, be carried out using Al. The training step for future image processing steps may thus, in particular, improve a method for determining the actual distribution, in particular the localization of the fertilizer grains in the image, and make the resulting results more accurate.

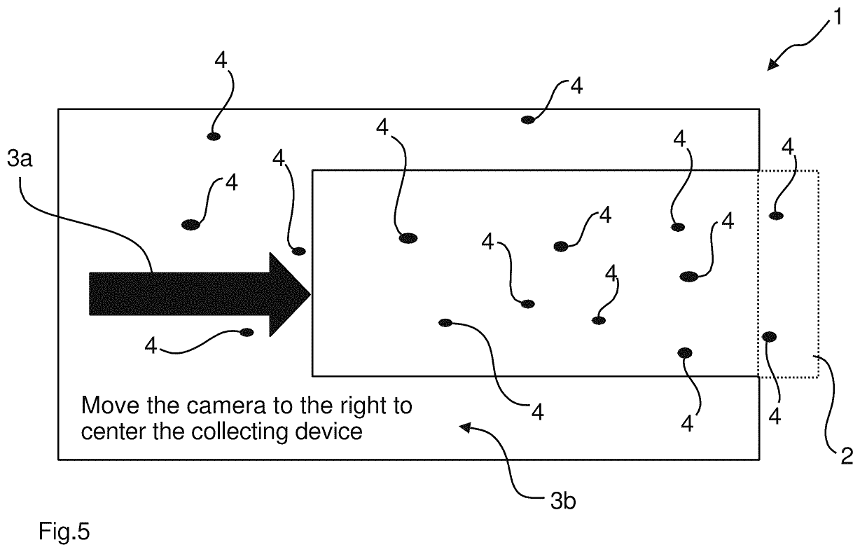

FIG. 5 shows an exemplary user interface that may be used in a method for determining an actual distribution of fertilizer grains or in a system for taking a picture in a method for determining an actual distribution of fertilizer grains.

The user interface may be displayed in particular on a display 1, e.g. the display of a mobile device. In the example shown, a collecting device 2 and fertilizer grains 4 are visible on and next to the collecting device 2. The collecting device is not centered in the image on the display 1 and the user is visually guided on the user interface, here exemplarily by an arrow 3a and instruction 3b, to move the camera so that the collecting device is centered.

After that, a picture may be taken. In other embodiments, the user guidance may additionally or alternatively comprise augmented reality and/or non-visual components, e.g., acoustic components such as a warning signal or other components, e.g., a vibration alarm.

1. A method for determining an actual distribution of fertilizer grains comprising:
(a) laying out at least one collecting device for fertilizer grains;
b) spreading the fertilizer grains over the at least one collecting device using a centrifugal fertilizer spreader;
c) taking a picture of the at least one collecting device on which fertilizer grains have been spread with a camera,
d) locating the fertilizer grains in the picture, and
e) calculating an actual distribution of the fertilizer grains on the collecting device and/or along several collecting devices,
wherein the method comprises at least one improvement step that improves the localization of the fertilizer grains in the picture.

2. The method according to claim 1, wherein the improvement step comprises capturing at least one circumstantial parameter before taking a picture.

3. The method according to claim 2, wherein at least one setting parameter is adjusted based on the at least one circumstantial parameter captured when taking a picture.

4. The method according to claim 2, wherein the at least one circumstantial parameter comprises an environmental parameter and/or a fertilizer spreader parameter.

5. The method according to claim 2, wherein the at least one circumstantial parameter comprises a camera parameter, wherein
an instruction for improving the at least one camera parameter is output and/or
wherein the picture is automatically taken when the at least one camera parameter fulfills certain conditions.

6. The method according to claim 1, wherein the improvement step comprises recognizing a region of interest, and wherein the picture is-ops cropped to the region of interest.

7. The method according to claim 1, wherein the improvement step comprises an image processing step that improves distinguishing the fertilizer grains from the background.

8. The method according to claim 7, wherein the image processing step that improves the distinguishing of the fertilizer grains from the substrate comprises a filtering step,
wherein the filtering step comprises a convolution step
and/or
wherein the filtering step comprises a dilation step and/or an erosion step
and/or histogram adjustment
and/or
wherein the filtering step comprises a fast Fourier transform and/or threshold filtering.

9. The method according to claim 2, wherein the improvement step is adapted taking into account the at least one circumstantial parameter
and/or
wherein the improvement step comprises a training step for future steps of a method for determining an actual distribution of fertilizer grains.

10. The method according to claim 1, wherein the improvement step comprises a compensation step for contaminants detected on the collecting device.

11. The method according to claim 1, wherein the image processing is parallelized.

12. The method according to claim 1, wherein the improvement step comprises guiding a user through the imaging process, in particular visually and/or acoustically guiding the user through the imaging process.

13. The method according to claim 1, wherein information about the collecting device is taken into account when calculating the actual distribution of the fertilizer grains.

14. The method according to claim 1, wherein the improvement step comprises a pixel-wise image segmentation using a neural network
and/or
wherein the improvement step comprises classifying or marking recognized objects using a neural network.

15. The method according to claim 1, wherein the improvement step comprises filtering using a specially trained neural network.

16. A system for taking a picture in a method for determining an actual distribution of fertilizer grains, characterized in that the system comprises a screen, a processor and a memory comprising instructions which, when carried out by a processor, visually and/or acoustically guide a user to taking a picture of the at least one collecting device on which fertilizer grains have been spread, wherein the memory comprises instructions which, when carried out by a processor, after picture taking comprise the steps of
localizing the fertilizer grains in the picture, and
calculating an actual distribution of the fertilizer grains on the collecting device and/or along several collecting devices,
wherein at least one improvement step improves the localization of the fertilizer grains in the picture.
